(19) United States
(12) Patent Application Publication
(10) Pub. No.: US 2014/0324991 A1
(43) Pub. Date: Oct. 30, 2014

(54) METHOD AND IM CLIENT DEVICE FOR PLAYING MULTIMEDIA MESSAGES AND IM SERVER

(71) Applicant: Xiao Long Zhang, Shenzhen (CN)

(72) Inventor: Xiao Long Zhang, Shenzhen (CN)

(21) Appl. No.: 13/993,632

(22) PCT Filed: Apr. 25, 2013
(86) PCT No.: PCT/CN13/74733

§ 371 Date: Jun. 12, 2013

(51) Int. Cl. H04L 12/58

(52) U.S. Cl. CPC H04L 51/10
USPC 709/206

(57) ABSTRACT

This disclosure provides methods for playing Multimedia messages, IM client devices and an IM server. One method includes receiving, by an Instant Messaging (IM) client device, N Multimedia messages from an IM server, checking, by the IM client device, whether an instruction instructing playing the N Multimedia messages automatically is received from the IM server, and playing, by the IM client device, the N Multimedia messages automatically if the instruction instructing playing the N Multimedia messages automatically is received from the IM server; wherein N is an integer larger than or equal to 1. This technical scheme provides a more convenient method for listening to or watching the Multimedia messages, and improves the experiences of the user.

### FIELD OF THE INVENTION

The present disclosure relates to a field of Instant Messaging (IM), and more particularly, to methods and IM client devices for playing Multimedia messages and an IM server.

### BACKGROUND

Instant Messaging (IM) is a form of communication over the Internet that offers quick transmission of messages from sender to receiver. It may address point-to-point communications as well as multicast communications from one sender to many receivers. More advanced instant messaging allows enhanced modes of communication, such as live voice or video calling, video chat and inclusion of hyperlink to media.

WeChat is a new and powerful IM tool. WeChat supports sending voice, video, photo and text messages. With the WeChat, the user may also do group chats, or find new friends nearby to talk to. WeChat works on devices, on which intelligent Operating Systems (OSs) are installed, such as iOS, Android, Windows Phone, Symbian and Blackberry. The devices, on which the intelligent OSs are installed, are called intelligent devices. The intelligent device, on which the IM software is installed, is called an IM client device. After the WeChat is installed on the IM client device, the user may log on the WeChat, open a session interface, and chat with a friend.

At present, a user may send Multimedia messages to his/her friend via the IM client device, and receive multiple Multimedia messages from his/her friends. Especially, when the Multimedia messages are received from the public ID, the user wishes that the Multimedia messages are played automatically when opening the session interface. In the conventional method, only when the user clicks on the Multimedia messages, the Multimedia messages are played. In some occasions, it is inconvenient for the user to click on the Multimedia messages, such as when the user is driving. Therefore, with the conventional method, it is inconvenient for listening to or watching the Multimedia messages.

### SUMMARY

In view of the above, the present disclosure provides methods and IM client devices for playing Multimedia messages and an IM server, by which the use may conveniently listen to or watch the received Multimedia messages.

A first example of the present disclosure provides a method for playing Multimedia messages, including:

receiving, by an Instant Messaging (IM) client device, N Multimedia messages from an IM server;

checking, by the IM client device, whether an instruction instructing playing the N Multimedia messages automatically is received from the IM server;

playing, by the IM client device, the N Multimedia messages automatically if the instruction instructing playing the N Multimedia messages automatically is received from the IM server; wherein N is an integer larger than or equal to 1.

A second example of the present disclosure provides a method for playing Multimedia messages, including:

determining, by an IM server, whether one or multiple Multimedia messages need to be played automatically;

sending, by the IM server, the one or multiple Multimedia messages to an IM client device; and

sending, by the IM server, an instruction instructing playing the one or multiple Multimedia messages automatically to the IM client device.

A third example of the present disclosure provides a method for playing Multimedia messages, including:

receiving, by an Instant Messaging (IM) client device, N Multimedia messages from an IM server;

checking, by the IM client device, whether the IM client device is configured as playing the N Multimedia messages automatically;

playing, by the IM client device, the N Multimedia messages automatically if the IM client device is configured as playing the N Multimedia messages automatically; wherein N is an integer larger than or equal to 1.

A fourth example of the present disclosure provides an IM client device for playing Multimedia messages, including: a processor, a memory, an interface and a viewing screen.

The interface is to receive N Multimedia messages from an IM server;

the memory is to store the N Multimedia messages;

the processor is to

check whether an instruction instructing playing the N Multimedia messages automatically is received from the IM server via the interface;

instruct the viewing screen to play the N Multimedia messages automatically if the instruction instructing playing the N Multimedia messages automatically is received from the IM server via the interface; wherein N is an integer larger than or equal to 1.

A fifth example of the present disclosure discloses an IM server including a processor and an interface.

The processor is to

determine whether one or multiple Multimedia messages need to be played automatically;

send the one or multiple Multimedia messages to an IM client device via the interface; and

send an instruction instructing the IM client device to play the one or multiple Multimedia messages automatically to the IM client device via the interface.

A sixth example of the present disclosure discloses an IM client device, including: a processor, a memory, an interface and a viewing screen.

The interface is to receive N Multimedia messages from an IM server;

the memory is to store the N Multimedia messages;

the processor is to

check whether the IM client device is configured as playing the N Multimedia messages automatically;

instruct the viewing screen to play the N Multimedia messages automatically if the IM client device is configured as playing the N Multimedia messages automatically; wherein N is an integer larger than or equal to 1.

In view of the above, examples of the present disclosure provide methods and IM client devices for playing Multimedia messages and an IM server. With the technical scheme, the IM client device may play the Multimedia messages automatically after receiving the Multimedia messages. By using the technical scheme, the user may listen to or watch the Multimedia messages without clicking on the Multimedia messages. This technical scheme provides a more convenient method for listening to or watching the Multimedia messages, and improves the experiences of the user. In addition, with the above technical scheme, the number of interactions between the user and the IM client device is reduced, which may reduce resource cost and load of the IM client device.

### BRIEF DESCRIPTION OF THE DRAWINGS

Features of the present disclosure are illustrated by way of non-limiting examples in the following figure(s), in which:

FIG. 1 is a flow charting illustrating a method for playing Multimedia messages in accordance with a first example of the present disclosure;

FIG. 2 is a flow chart illustrating a method for playing Multimedia messages in accordance with a second example of the present disclosure;

FIG. 3 is a flow chart illustrating a method for playing Multimedia messages in accordance with a third example of the present disclosure;

FIG. 4 is a schematic diagram illustrating an IM client device in accordance with a first example of the present disclosure;

FIG. 5 is a schematic diagram illustrating an IM server in accordance with a second example of the present disclosure;

FIG. 6 is a schematic diagram illustrating an IM client device in accordance with a third example of the present disclosure;

FIG. 7 is a schematic diagram illustrating an IM client device in accordance with a fourth example of the present disclosure;

FIG. 8 is a schematic diagram illustrating an IM server in accordance with a fifth example of the present disclosure; and

FIG. 9 is a schematic diagram illustrating an IM client device in accordance with a sixth example of the present disclosure.

### DETAILED DESCRIPTION

For simplicity and illustrative purposes, the present disclosure is described by referring to non-limiting examples. In the following description, numerous specific details are set forth in order to provide a thorough understanding of the present disclosure. It will be readily apparent however, that the present disclosure may be practiced without limitation to these specific details. In some instances, some methods and structures have not been described in detail so as not to unnecessarily obscure the present disclosure. As used throughout the present disclosure, the term “includes” means includes but not limited to, the term “including” means including but not limited to. The term “based on” means based at least in part on. In addition, the terms “a” and “an” are intended to denote at least one of a particular element.

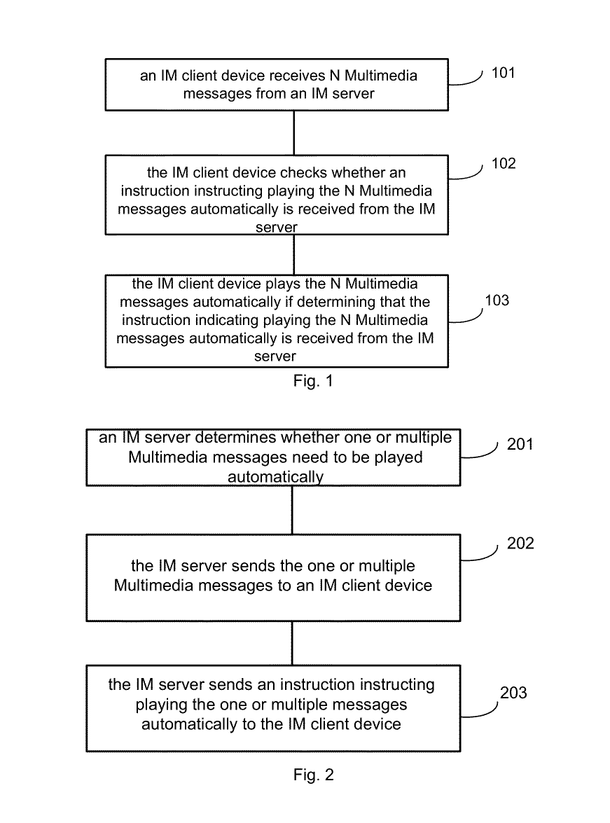

Referring to FIG. 1, FIG. 1 is a flow charting illustrating a method for playing Multimedia messages in accordance with a first example of the present disclosure. The method includes the following blocks.

In block 101, an IM client device receives N Multimedia messages from an IM server.

In this block, N is an integer larger than or equal to 1.

In block 102, the IM client device checks whether an instruction instructing playing the N Multimedia messages automatically is received from the IM server.

In this block, the instruction instructing playing the N Multimedia messages automatically may be a tag or a flag bit. For instance, it is determined that the N Multimedia messages should be played automatically when the tag is received from the IM server. Alternatively, if the value of the flag bit is “1”, it is determined that the N Multimedia messages should be played automatically. If the value of the flag bit is “0”, it is determined that the N Multimedia messages should not be played automatically.

In block 103, the IM client device plays the N Multimedia messages automatically if determining that the instruction indicating playing the N Multimedia messages automatically is received from the IM server.

In view of the above, a method for automatically playing the received Multimedia messages is provided. By using the method, the user may listen to or watch the Multimedia messages without clicking on the Multimedia messages. This technical scheme provides a more convenient method for listening to or watching the Multimedia messages, and improves the experiences of the user.

In block 103, if the value of N is 1, the method for playing the Multimedia message is as follows.

In this block, if N equals to 1, the IM client device plays the Multimedia message automatically if determining that the instruction instructing playing the Multimedia message automatically is received from the IM server.

If N equals to 1 and the instruction instructing playing the Multimedia message automatically is not received from the IM server, the IM client device plays the Multimedia message upon receiving the request for playing the Multimedia message from the user.

If the value of N is larger than 1, the method for playing the Multimedia messages is as follows.

If determining that the instruction instructing playing the Multimedia messages automatically is received from the IM server and N is larger than 1, the IM client device plays the N Multimedia messages automatically and continuously. Taking N equals to 4 for example, after determining that instruction is received form the IM server, the IM client device automatically plays the first Multimedia message, and then plays the second, third and fourth Multimedia messages one by one.

In an alternative example, if determining that the instruction instructing playing the Multimedia message automatically is received from the IM server and N is larger than 1, the IM client device plays the first one of the N

Multimedia messages automatically, and plays an Mth Multimedia message to the Nth Multimedia message continuously when a user clicks on the Mth Multimedia message. M is an integer larger than 1 and less than N. Similarly, taking N equals to 4 for example, the IM client device plays the first Multimedia message automatically. If the user clicks on the second Multimedia message, the IM client device plays the second Multimedia message to the fourth Multimedia message one by one.

If determining that the instruction instructing playing the Multimedia message automatically is not received from the IM server and N is larger than 1, the IM client device plays a Pth Multimedia message to the Nth Multimedia message continuously if the user clicks on the Pth Multimedia message. P is an integer larger than or equal to 1 and less than N. Taking N equals to 4 for example, after receiving the four Multimedia messages from the IM server, if the user clicks on the second Multimedia messages, the IM client device plays the second to the fourth Multimedia messages.

In view of the above, when multiple Multimedia messages are received from the IM server, the IM client device may play the Multimedia messages continuously and automatically. In this way, in order to listen to or watch the multiple Multimedia messages, the user needs not to click on each of the received Multimedia messages. In stead, if the user clicks on one of them, the IM client device plays the clicked one to the last one of the Multimedia messages one by one. This scheme provides an easier way to listen to or watch the Multimedia messages and improves the experiences of the user.

Referring to FIG. 2, FIG. 2 is a flow chart illustrating a method for playing Multimedia messages in accordance with a second example of the present disclosure. The method includes the following blocks.

In block 201, an IM server determines whether one or multiple Multimedia messages need to be played automatically.

In this block, the IM server determines whether a public ID or a private ID sending the one or multiple Multimedia messages has subscribed an autoplay function. The IM server determines that the one or multiple Multimedia messages need to be played automatically if the public ID or the private ID sending the one or multiple Multimedia messages has subscribed the autoplay function.

In practice, more public IDs subscribe the autoplay function. The public IDs are owned by Companies, brands and celebrities registering on a public platform and providing services to the private IDs who concern them, such as selling stuff or sending news update, discount voucher, company announcements to the private IDs. Typically, the Multimedia messages sent from the public IDs do not include privacy. Therefore, the IM server prefers to authenticate the autoplay function to the public IDs.

In block 202, the IM server sends the one or multiple Multimedia messages to an IM client device.

In block 203, the IM server sends an instruction instructing playing the one or multiple messages automatically to the IM client device.

With this example, the IM server sends the one or multiple Multimedia messages and the instruction instructing playing the one or multiple messages automatically to the IM client device. After receiving the Multimedia messages and the instruction, the IM client device plays the Multimedia messages automatically.

In the above mentioned methods, the IM client determines whether to play the received Multimedia messages automatically according to the instruction received from the IM server. Hereinafter, a method for determining whether to play the received Multimedia messages automatically according to the configuration of the IM client device is provided hereinafter.

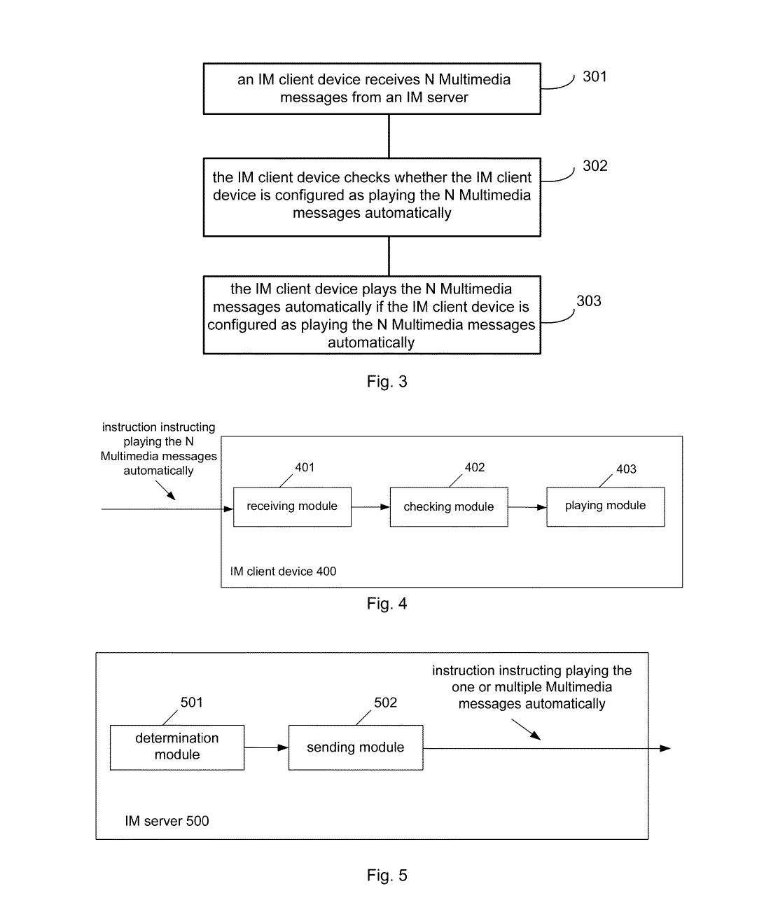

Referring to FIG. 3, FIG. 3 is a flow chart illustrating a method for playing Multimedia messages in accordance with a third example of the present disclosure. The method includes the following blocks.

In block 301, an IM client device receives N Multimedia messages from an IM server.

In this block, N is an integer larger than or equal to 1.

In block 302, the IM client device checks whether the IM client device is configured as playing the N Multimedia messages automatically.

The IM client device may be a mobile phone. IM software, such as

WeChat may be installed on the mobile phone. Two options indicating playing the Multimedia messages automatically and not playing the Multimedia messages automatically may be set in the WeChat. If the user may select the option indicating playing the Multimedia messages automatically and also may select the option indicating not playing the Multimedia messages automatically. For instance, a slider is set in settings of the WeChat. When the user pushes the slider to the right, the IM client device is configured as playing the Multimedia messages automatically. In the alternative, when the user pushes the slider to the left, the IM client device is configured as not playing the Multimedia messages automatically.

In block 303, the IM client device plays the N Multimedia messages automatically if the IM client device is configured as playing the N Multimedia messages automatically.

First, if the value of N is 1, the method for playing the Multimedia message is as follows.

In this block, if N equals to 1, the IM client device plays the Multimedia message automatically if the IM client device is configured as playing the Multimedia message automatically.

If N equals to 1 and the IM client device is configured as not playing the Multimedia message automatically, the IM client device plays the Multimedia message upon receiving a request for playing the Multimedia message from the user.

Second, if the value of N is larger than 1, the method for playing the Multimedia messages is as follows.

If determining that the IM client device is configured as playing the Multimedia messages automatically and N is larger than 1, the IM client device plays the N Multimedia messages automatically and continuously. Taking N equals to 4 for example, after determining that IM client device is configured as playing the Multimedia messages automatically, the IM client device automatically plays the first Multimedia message, and then plays the second, third and fourth Multimedia messages one by one.

In an alternative example, if determining that the IM client device is configured as playing the Multimedia messages automatically and N is larger than 1, the IM client device plays the first one of the N Multimedia messages automatically, and plays an Mth Multimedia message to the Nth Multimedia message continuously when a user clicks on the Mth Multimedia message. M is an integer larger than 1 and less than N. Similarly, taking N equals to 4 for example, the IM client device plays the first Multimedia message automatically. If the user clicks on the third Multimedia message, the IM client device plays the third Multimedia message and then plays the fourth Multimedia message after playing the third Multimedia message.

If determining that the IM client device is configured as not playing the Multimedia messages automatically and N is larger than 1, the IM client device does not play the Multimedia message automatically, instead, the IM client device plays a Pth Multimedia message to the Nth Multimedia message continuously if the user clicks on the Pth Multimedia message. P is an integer larger than or equal to 1 and less than N. Taking N equals to 4 for example, after receiving the four Multimedia messages from the IM server, if the user clicks on the second Multimedia messages, the IM client device plays the second to the fourth Multimedia messages continuously.

Referring to the examples in the accompanying drawings, the Multimedia messages may be played as following using the devices.

Referring to FIG. 4, FIG. 4 is a schematic diagram illustrating an IM client device in accordance with a first example of the present disclosure. The IM client device 400 includes a receiving module 401, a checking module 402 and a playing module 403.

The receiving module 401 is to receive N Multimedia messages from an IM server. N is an integer larger than or equal to 1

The checking module 402 is to check whether an instruction instructing playing the N Multimedia messages automatically is received from the IM server.

The playing module 403 is to play the N Multimedia messages automatically if the instruction instructing playing the N Multimedia messages automatically is received from the IM server.

In this IM client device, when N is larger than 1, the playing module 403 is further to play the N Multimedia messages automatically and continuously.

In the alternative, when N is larger than 1, the playing module 403 is further to play the first one of the N Multimedia messages automatically, play, when a user clicks on an Mth Multimedia message, the Mth Multimedia message to the Nth Multimedia message continuously. M is an integer larger than 1 and less than N.

Referring to FIG. 5, FIG. 5 is a schematic diagram illustrating an IM server in accordance with a second example of the present disclosure. The IM server 500 includes a determination module 501 and a sending module 502.

The determination module 501 is to determine whether one or multiple Multimedia messages need to be played automatically.

The sending module 502 is to send the one or multiple Multimedia messages to an IM client device, and send an instruction instructing playing the one or multiple Multimedia messages automatically to the IM client device.

In the alternative, the determination module 501 is further to determine whether a public ID or a private ID sending the one or multiple Multimedia messages has subscribed an autoplay function, and determine that the one or multiple Multimedia messages need to be played automatically if the public ID or the private ID sending the one or multiple Multimedia messages has subscribed the autoplay function.

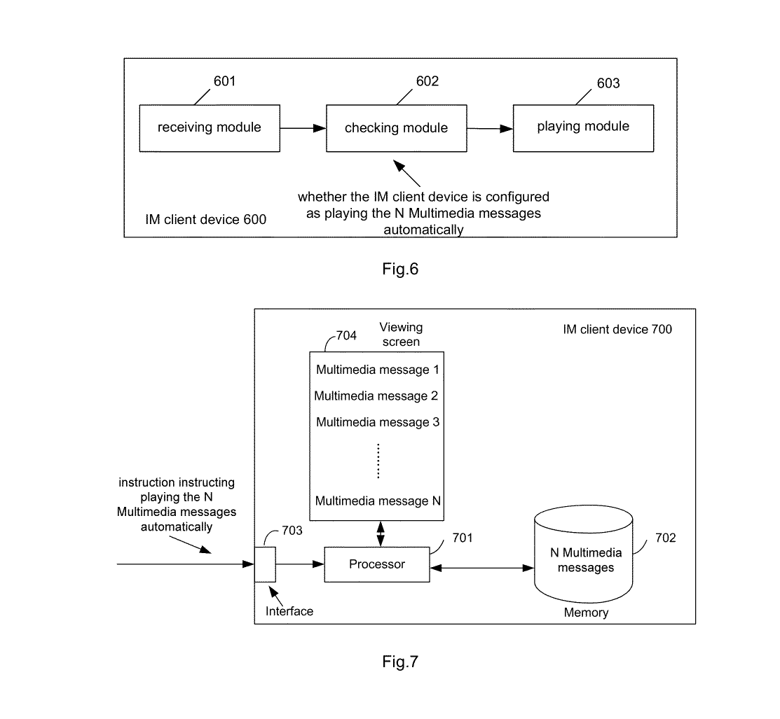

Referring to FIG. 6, FIG. 6 is a schematic diagram illustrating an IM client device in accordance with a third example of the present disclosure. The IM client device 600 includes: a receiving module 601, a checking module 602, and a playing module 603.

The receiving module 601 is to receive N Multimedia messages from an IM server.

The checking module 602 is to check whether the IM client device is configured as playing the N Multimedia messages automatically.

The playing module 603 is to play the N Multimedia messages automatically if the IM client device is configured as playing the N Multimedia messages automatically. N is an integer larger than or equal to 1.

In the alternative, when N is larger than 1, the playing module 603 is further to play the N Multimedia messages automatically and continuously.

In another example, when N is larger than 1, the playing module 603 is further to play the first one of the N Multimedia messages automatically, and play, when a user clicks on an Mth Multimedia message, the Mth Multimedia message to the Nth Multimedia message continuously. M is an integer larger than 1 and less than N.

Referring to FIG. 7, FIG. 7 is a schematic diagram illustrating an IM client device in accordance with a fourth example of the present disclosure. The IM client device 700 includes a processor 701, a memory 702, an interface 703 and a viewing screen 704.

The interface 703 is to receive N Multimedia messages from an IM server.

The memory 702 is to store the N Multimedia messages.

The processor 701 is to check whether an instruction instructing playing the N Multimedia messages automatically is received from the IM server via the interface 703, instruct the viewing screen 704 to play the N Multimedia messages automatically if the instruction instructing playing the N Multimedia messages automatically is received from the IM server via the interface 703. N is an integer larger than or equal to 1.

When N is larger than 1, the processor 701 is further to instruct the viewing screen 704 to play the N Multimedia messages automatically and continuously.

When N is larger than 1, the processor 701 is further to instruct the viewing screen 704 to play the first one of the N Multimedia messages automatically, and instruct the viewing screen 704 to play, when a user clicks on an Mth Multimedia message, the Mth Multimedia message to the Nth Multimedia message continuously. M is an integer larger than 1 and less than N.

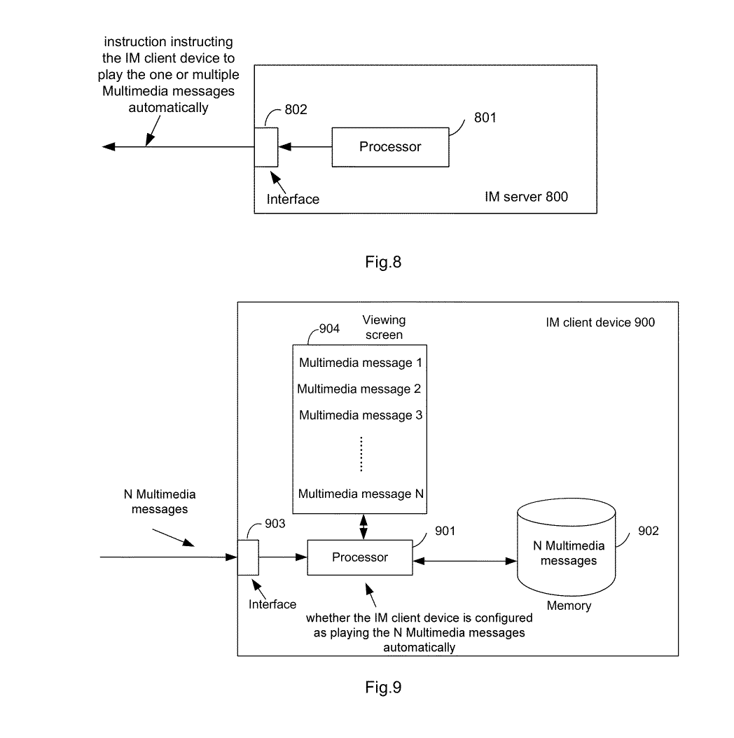

Referring to FIG. 8, FIG. 8 is a schematic diagram illustrating an IM server in accordance with a fifth example of the present disclosure. The IM server includes a processor 801 and an interface 802.

The processor 801 is to determine whether one or multiple

Multimedia messages need to be played automatically, send the one or multiple Multimedia messages to an IM client device via the interface 802, and send an instruction instructing the IM client device to play the one or multiple Multimedia messages automatically to the IM client device via the interface 802.

In an example, the processor 801 is further to determine whether a public ID or a private ID sending the one or multiple Multimedia messages has subscribed an autoplay function, and determine that the one or multiple Multimedia messages need to be played automatically if the public ID or the private ID sending the one or multiple Multimedia messages has subscribed the autoplay function.

Referring to FIG. 9, FIG. 9 is a schematic diagram illustrating an IM client device in accordance with a sixth example of the present disclosure. The IM client device 900 includes a processor 901, a memory 902, an interface 903 and a view screen 904.

The interface 903 is to receive N Multimedia messages from an IM server.

The memory 902 is to store the N Multimedia messages.

The processor 901 is to check whether the IM client device 900 is configured as playing the N Multimedia messages automatically, instruct the viewing screen 904 to play the N Multimedia messages automatically if the IM client device 900 is configured as playing the N Multimedia messages automatically. N is an integer larger than or equal to 1.

In an example, when N is larger than 1, the processor 901 is further to instruct the viewing screen 904 to play the N Multimedia messages automatically and continuously.

In an example, when N is larger than 1, the processor 901 is further to instruct the viewing screen 904 to play the first one of the N Multimedia messages automatically, and instruct the viewing screen 904 to play, when a user clicks on an Mth Multimedia message, the Mth Multimedia message to the Nth Multimedia message continuously. M is an integer larger than 1 and less than N.

As will be appreciated by one skilled in the art, aspects of the disclosed IM client devices and IM server disclosed herein may be embodied as a system, method or computer program product. Accordingly, aspects of the IM client devices and the IM server may take the form of an hardware embodiment, an software embodiment or an embodiment combining software and hardware aspects that may all generally be referred to herein as a “circuit”, “module” or “system”. Furthermore, aspects of the IM client devices and IM server may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), a digital versatile disk (DVD), an erasable programmable read-only memory (EPROM or Flash memory), an optical fiber, a portable compact disc read-only memory (CD-ROM), an optical storage device, a magnetic storage device, or any tangible medium that can contain, or store a program for use by or in connection with an instruction execution system, apparatus, or device.

The figures are only illustrations of an example, wherein the modules or procedure shown in the figures are not necessarily essential for implementing the present disclosure. The modules in the aforesaid examples can be combined into one module or further divided into a plurality of sub-modules.

The above are examples of the disclosure along with some variations.

The terms, descriptions and figures used herein are set forth by way of illustration only and are not meant as limitations. Many variations are possible within the scope of the disclosure, which is intended to be defined by the following claims—and their equivalents—in which all terms are meant in their broadest reasonable sense unless otherwise indicated.

What is claimed is:

1. A method for playing Multimedia messages, comprising:
receiving, by an Instant Messaging (IM) client device, N Multimedia messages from an IM server;
checking, by the IM client device, whether an instruction instructing playing the N Multimedia messages automatically is received from the IM server; and
playing, by the IM client device, the N Multimedia messages automatically if the instruction instructing playing the N Multimedia messages automatically is received from the IM server; wherein N is an integer larger than or equal to 1.

2. The method according to claim 1, wherein when N is larger than 1, playing, by the IM client device, the N Multimedia messages automatically comprises:
playing, by the IM client device, the N Multimedia messages automatically and continuously.

3. The method according to claim 1, wherein when N is larger than 1, playing, by the IM client device, the N Multimedia messages automatically comprises:
playing, by the IM client device, the first one of the N Multimedia messages automatically; and
playing, by the IM client when a user clicks on an Mth Multimedia message, the Mth Multimedia message to an Nth Multimedia message continuously; wherein
M is an integer larger than 1 and less than N.

4. A method for playing Multimedia messages, comprising:
determining, by an IM server, whether one or multiple Multimedia messages need to be played automatically;
sending, by the IM server, the one or multiple Multimedia messages to an IM client device; and
sending, by the IM server, an instruction instructing playing the one or multiple Multimedia messages automatically to the IM client device.

5. The method according to claim 4, wherein determining, by the IM server, whether the one or multiple Multimedia messages need to be played automatically comprises:
determining, by the IM server, whether a public ID or a private ID sending the one or multiple Multimedia messages has subscribed an autoplay function; and
determining, by the IM server, that the one or multiple Multimedia messages need to be played automatically if the public ID or the private ID sending the one or multiple Multimedia messages has subscribed the autoplay function.

6. A method for playing Multimedia messages, comprising:
receiving, by an Instant Messaging (IM) client device, N Multimedia messages from an IM server;
checking, by the IM client device, whether the IM client device is configured as playing the N Multimedia messages automatically;
playing, by the IM client device, the N Multimedia messages automatically if the IM client device is configured as playing the N Multimedia messages automatically; wherein N is an integer larger than or equal to 1.

7. The method according to claim 6, wherein when N is larger than 1, playing, by the IM client device, the N Multimedia messages automatically comprises:
playing, by the IM client device, the N Multimedia messages automatically and continuously.

8. The method according to claim 6, wherein when N is larger than 1, playing, by the IM client device, the N Multimedia messages automatically comprises:
playing, by the IM client device, the first one of the N Multimedia messages automatically;
playing, by the IM client when a user clicks on an Mth Multimedia message, the Mth Multimedia message to an Nth Multimedia message continuously; wherein
M is an integer larger than 1 and less than N.

9. An IM client device for playing Multimedia messages, comprising: a processor, a memory, an interface and a viewing screen; wherein
the interface is to receive N Multimedia messages from an IM server;
the memory is to store the N Multimedia messages;
the processor is to
check whether an instruction instructing playing the N Multimedia messages automatically is received from the IM server via the interface;
instruct the viewing screen to play the N Multimedia messages automatically if the instruction instructing playing the N Multimedia messages automatically is received from the IM server via the interface; wherein N is an integer larger than or equal to 1.

10. The IM client device according to claim 9, wherein when N is larger than 1, the processor is further to instruct the viewing screen to play the N Multimedia messages automatically and continuously.

11. The IM client device according to claim 9, wherein when N is larger than 1, the processor is further to
instruct the viewing screen to play the first one of the N Multimedia messages automatically; and
instruct the viewing screen to play, when a user clicks on an Mth Multimedia message, the Mth Multimedia message to an Nth Multimedia message continuously; wherein M is an integer larger than 1 and less than N.

12. An IM server, comprising: a processor and an interface; wherein
the processor is to
determine whether one or multiple Multimedia messages need to be played automatically;
send the one or multiple Multimedia messages to an IM client device via the interface; and
send an instruction instructing the IM client device to play the one or multiple Multimedia messages automatically to the IM client device via the interface.

13. The IM server according to claim 12, wherein the processor is further to
determine whether a public ID or a private ID sending the one or multiple Multimedia messages has subscribed an autoplay function; and
determine that the one or multiple Multimedia messages need to be played automatically if the public ID or the private ID sending the one or multiple Multimedia messages has subscribed the autoplay function.

14. An IM client device, comprising: a processor, a memory, an interface and a viewing screen; wherein
the interface is to receive N Multimedia messages from an IM server;
the memory is to store the N Multimedia messages;
the processor is to
check whether the IM client device is configured as playing the N Multimedia messages automatically;
instruct the viewing screen to play the N Multimedia messages automatically if the IM client device is configured as playing the N Multimedia messages automatically; wherein N is an integer larger than or equal to 1.

15. The IM client device according to claim 14, wherein when N is larger than 1, the processor is further to instruct the viewing screen to play the N Multimedia messages automatically and continuously.

16. The IM client device according to claim 14, when N is larger than 1, the processor is further to
instruct the viewing screen to play the first one of the N Multimedia messages automatically; and
instruct the viewing screen to play, when a user clicks on an Mth Multimedia message, the Mth Multimedia message to an Nth Multimedia message continuously; wherein M is an integer larger than 1 and less than N.
